(19) United States
(12) Patent Application Publication
(10) Pub. No.: US 2020/0016790 A1
(43) Pub. Date: Jan. 16, 2020

(54) SYSTEM FOR ADDING LIQUID COLOR PIGMENT TO CONCRETE IN A VOLUMETRIC TYPE MIXER

(71) Applicants: Dennis Wayne Cooper, Franklin, KY (US); Robin Wayne Cooper, Franklin, KY (US)

(72) Inventors: Dennis Wayne Cooper, Franklin, KY (US); Robin Wayne Cooper, Franklin, KY (US)

(21) Appl. No.: 16/509,039

(22) Filed: Jul. 11, 2019

Related U.S. Application Data
(60) Provisional application No. 62/696,586, filed on Jul. 11, 2018.

(51) Int. Cl. B28C 5/42

(52) U.S. Cl. CPC B28C 5/4258; B28C 7/0876; B28C 5/4213

(57) ABSTRACT

A pigment and concrete mixer includes a pigment tank fluidly connected to a mixing auger by a hose. A pump is configured to pump pigment from the pigment tank to the mixing auger. A motor is operable to control the pump and adjust a flow rate of the pigment within the hose. The present invention adds color pigment to concrete in controlled flow for consistent color throughout concrete mix. The flow is adjusted to different rates for different color variation.

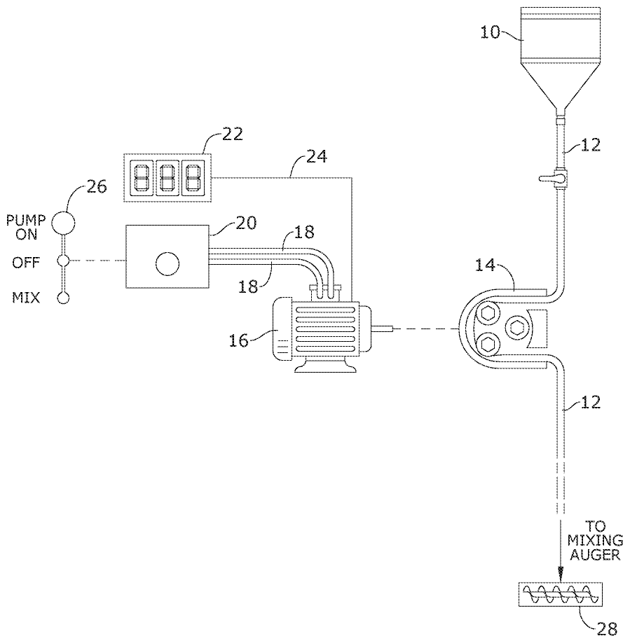

### CROSS-REFERENCE TO RELATED APPLICATION

This application claims the benefit of priority of U.S. provisional application No. 62/696,586, filed Jul. 11, 2018, the contents of which are herein incorporated by reference.

### BACKGROUND OF THE INVENTION

The present invention relates to colored concrete and, more particularly, to a system and method for providing a consistent flow of pigment to concrete.

Decorative concrete is the use of concrete as not simply a utilitarian medium for construction but as an aesthetic enhancement to a structure, while still serving its function as an integral part of the building itself such as floors, walls, driveways, and patios.

The transformation of concrete into decorative concrete is achieved through the use of a variety of materials that may be applied during the pouring process.

Concrete dyes take many different forms and compositions and can be used on both residential and commercial concrete applications, including sound/retaining walls, bridges, countertops, floors, etc.

Early concrete dyes consisted of generic printing inks that were dissolved in mild solutions of alcohol and applied to concrete surfaces to add a wide array of color to plain gray concrete. When alcohol-based dyes are exposed to sunlight, the color either lightens or fades out completely. Therefore, alcohol-based dyes were more prevalent in interior applications where direct sunlight or other forms of ultraviolet (UV) lighting was not present.

Manufacturers later began dissolving the same printing inks in different carriers, such as acetone, lacquer thinner and other solvents, hoping to achieve increased penetration levels. In addition, UV inhibiting agents were added to new dyes to help with the UV instability issues. However, slight fading (5-8% per year) still occurs when the dye is exposed to direct sunlight.

Current methods of adding pigment to concrete in a volumetric type mixer include an inconsistent flow of pigment, which causes discoloration in the concrete mix.

As can be seen, there is a need for a system and method for providing a consistent flow of pigment to concrete.

### SUMMARY OF THE INVENTION

In one aspect of the present invention, a system to dispense color pigment to a mixing auger on a volumetric type concrete mixer comprises: a pigment tank; a hose running from the pigment tank; a pump configured to pump pigment from the pigment tank to the mixing auger on a volumetric mixer; and a motor operable to control the pump and adjust a flow rate of the pigment within the hose.

In another aspect of the present invention, a method of mixing pigment with concrete comprises: providing a pigment pump comprising: a pigment tank; a hose running from the pigment tank; a pump coupled to the hose; and a motor coupled to the pump; and pumping pigment from the pigment tank through the hose and into a concrete mixing auger, wherein a flow rate of the pigment within the hose is adjustable by controlling a speed of the motor.

These and other features, aspects and advantages of the present invention will become better understood with reference to the following drawings, description and claims.

### BRIEF DESCRIPTION OF THE DRAWINGS

The FIGURE is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Referring to the FIGURE, the present invention includes a system to dispense color pigment to a mixing auger on a volumetric type mixer. The system to dispense color pigment to a mixing auger on a volumetric type mixer includes a pigment tank 10 fluidly connected to a mixing auger 28 by a hose 12. A pump 14 is configured to pump pigment from the pigment tank 10 to the mixing auger 28. A motor 16 is operable to control the pump 14 and adjust a flow rate of the pigment within the hose 12. The present invention adds color pigment to concrete in controlled flow for consistent color though out concrete mix. The flow is adjusted to different rates for different color variation.

The pigment tank 10 may be a cylindrical cone and may be made of plastic. The pump 14 may be a bidirectional pump. Initially, the color pigment is pumped from a shipping container into the pigment tank 10 through the hose 12. The pump 14 is then reversed, and color pigment is pumped into the mixing auger 28.

In certain embodiments, the pump 14 is a peristaltic pump and the hose 12 is a peristaltic hose. The motor 16 may be a hydraulic motor having a hydraulic control valve 20 and hydraulic hoses 18. A controller 26 is operable to control the hydraulic control valve 20 and thereby control a speed of the motor 16 to adjust the flow rate of the pigment within the hose 12. The use of hydraulic motor 16, pump 14, and control valves 20 gives consistent flow of color pigment.

The present invention may further include a digital output 22 coupled to a speed sensor 24. The speed sensor 24 detects the speed of the motor 16 and the digital output 22 displays a numerical speed of the motor 16. Therefore, a user may visually see the speed of the motor 16 and therefore know the flow rate of the color pigment. The speed of the hydraulic motor 16 controls the flow rate of the color pigment. The present invention also allows for adding high viscosity liquid to the mixer at controlled and monitored rate.

A method of mixing pigment with concrete may include the following. Provide the pigment tank 10, hose 12, pump 14, and motor 16 described above. Pump pigment from a pigment container to the pigment tank 10. Pump pigment from the pigment tank 10 through the hose 12 and into a concrete mixing auger 28. A controlled amount of concrete is mixed with the pigment in the mixing auger 28 to create the colored concrete. A flow rate of the pigment within the hose 12 is adjustable by controlling a speed of the motor.

It should be understood, of course, that the foregoing relates to exemplary embodiments of the invention and that modifications may be made without departing from the spirit and scope of the invention as set forth in the following claims.

What is claimed is:

1. A pigment and concrete mixer comprising:
a pigment tank;
a hose running from the pigment tank to a mixing auger;
a pump configured to pump pigment from the pigment tank to the mixing auger; and
a motor operable to control the pump and adjust a flow rate of the pigment within the hose.

2. The pigment and concrete mixer of claim 1, wherein the pump is a peristaltic pump.

3. The pigment and concrete mixer of claim 1, wherein the motor is a hydraulic motor comprising a hydraulic control valve and hydraulic pumps.

4. The pigment and concrete mixer of claim 3, further comprising a controller operable to control the hydraulic control valve and thereby control a speed of the motor to adjust the flow rate of the pigment within the hose.

5. The pigment and concrete mixer of claim 4, further comprising a speed sensor and a digital output coupled to the speed sensor, wherein the speed sensor detects the speed of the motor and the digital output displays a numerical speed of the motor.

6. A method of mixing pigment with concrete comprising:
providing a pigment pump comprising:
a pigment tank;
a hose running from the pigment tank;
a pump coupled to the hose; and
a motor coupled to the pump; and
pumping pigment from the pigment tank through the hose and into a concrete mixing auger of a volumetric type mixer, wherein
a flow rate of the pigment within the hose is adjustable by controlling a speed of the motor.

7. The method of claim 6, wherein the pump is a peristaltic pump.

8. The method of claim 6, wherein the motor is a hydraulic motor comprising a hydraulic control valve and hydraulic pumps.

9. The method of claim 8, wherein the flow rate is adjustable via a controller controlling the hydraulic control valve and thereby controlling the speed of the motor to adjust the flow rate of the pigment within the hose.

10. The method of claim 6, wherein a speed sensor detects the speed of the motor and a digital output displays a numerical speed of the motor.
